(19) United States
(12) Patent Application Publication
(10) Pub. No.: US 2007/0272320 A1
(43) Pub. Date: Nov. 29, 2007

(54) Reusable duct wrap

(76) Inventor: James Roberson, Yucaipa, CA (US)

Correspondence Address: James Roberson, 12995 6th Street, SPC#44, Yucaipa, CA, 92399, US

(21) Appl. No.: 11/440,200

(22) Filed: May 24, 2006

(51) Int. Cl. F16L 9/14

(52) U.S. Cl. 138/149; 138/167

(57) ABSTRACT

An insulated duct wrap comprising an encasing exterior film which surrounds an insulation material and which is configured to wrap around the ductwork, said exterior film having an aperture to permit the escape of air and a fastening system at each end for securing the wrap to the duct.

### FIELD OF THE INVENTION

The present invention is directed toward a reusable duct wrap for exterior cooling/heating ducts on roof mounted or side mounted ductwork.

### BACKGROUND OF THE INVENTION

Most of the nation's commercial and residential buildings have thermal distribution systems, the majority (63%) of which are air-based and distribute air through ductworks. Thermal distribution ductwork systems in commercial buildings are similar to those in residential construction and have the same leakage and conduction-loss problems. The extent of these duct-related thermal losses depends on the location of the ductwork—the largest thermal losses occur when the ducts are entirely outside the building envelope.

Leakage, conduction losses, direct solar radiation effects and solar reflection all affect the magnitude of thermal loss. Differences in the lengths of exterior ducts also affect a distribution system's energy efficiency, as well as the temperature of air delivered to interior spaces at the registers. When long duct runs are exposed to sunlight and high outdoor temperatures on roofs, the supply air can experience a significant configuration temperature rise before reaching the registers during periods of demand for interior cooling. This configuration has a direct impact on interior thermal comfort conditions and can cause uneven temperature distribution within the building.

There have been a number of patents directed to the field of duct insulation. U.S. Patent Application No. 20050211839 to Movsesian discloses a modularized insulation blanket for thermal and/or acoustical insulation. The modularized insulation blanket has a cover formed of a distal layer and proximal layer in sealed mated relationship. The distal and proximal layers are sealed along longitudinal and latitudinal heat-sealed seams that define a plurality of modules. The heat-sealed seam may be creased so as to be foldable and/or perforated to provide a tear line. Within the modules are batting blocks. The blankets may be attached to surface structures such as the interior skin surface of an aircraft fuselage, pipes or other structures with retention systems. The blankets may be formed in an apparatus including a platen, heat seal rollers or heating sealing mechanisms, and edge sealers.

U.S. Patent Application No 20040079431 to Kissell discloses a pipe blanket which is provided for wrapping around and insulating a pipe. The pipe blanket comprises an insulation mat having an outer surface and an inner surface adapted to lie adjacent the pipe when the pipe blanket is wrapped around the pipe. An outer cover of the pipe blanket is coupled to the outer surface of the insulation mat. The insulation mat is configured to enclose a variety of pipes having different sized diameters. The pipe blanket further includes a closure means configured for securing the insulation mat and outer cover about the pipe. The insulation mat further includes a plurality of pleats.

U.S. Patent Application No. 20040238057 to Crim discloses an insulated duct assembly including an elongated duct, an insulation blanket, at least one sheet of escape wick material and a tape layer. The insulation blanket has an inner wicking layer. The insulation blanket is applied to the elongated duct so as to create a seam aligned longitudinally with respect to the duct. The seam is defined by first and second edges of the insulation blanket. The at least one sheet of escape wick material is disposed along at least one edge of the insulation blanket. The at least one sheet of escape wick material has a “C” shaped cross-section surrounding the at least one edge of the insulation blanket. The tape layer is disposed along and covers the seam.

U.S. Patent Application No. 20040043686 to Batdorf discloses an antimicrobial article in a sheet form including a porous sheeting substrate impregnated with a water-based antimicrobial composition comprising at least one polymeric emulsion or dispersion and at least one antimicrobial component that is substantially non-leaching and free of environmental hazardous material. The antimicrobial article may further comprise an adhesive coating disposed on at least one surface of the antimicrobial article. A removable protective film may be held to the exposed surface of the adhesive coating. The invention also provides a process of manufacturing the antimicrobial article. The antimicrobial article can be used, e.g., over fiberglass pipe insulation, on air duct liners, in building wall cavities, over gypsum wallboard and other construction surfaces.

U.S. Pat. No. 5,988,264 to Goldsmith discloses a system for cooling, heating and fire-protecting an enclosure or dwelling, consisting of six principal entities acting in cooperation. The first is an expansive system of wide, shallow ducting installed just outboard and against the innermost wall layers of the peripheral walls, ceiling and at times, the floor, thermally intimate but physically isolated from the interior volume of the enclosure. The second is an evaporatively-cooled air source, supplying the duct system, which cools the innermost wall layers and in turn, the interior volume, by radiation and convection. The third entity, being an encompassing layer of efficient insulation, just outboard of the ducting and within the enclosure, biasing the cooling and heating action to the interior volume. The fourth is a network of hot-water circulating tubes, lying within, or adjacent to said cooling ducts, and against the innermost wall layer, or inboard plate thereof. The fifth entity utilizes the in-place source of water in the peripheral walls and ceiling, for incorporation of heat-activated fire a suppression units therein, spraying into both, rooms and the duct system, as well. The last (sixth) entity provides for humidity control, convection, and ‘sensible’ cooling of infiltration air by a limited size, integral air-conditioner and independent air circulation fans within the interior volume of the enclosure or dwelling.

U.S. Pat. No. 4,766,283 to McCorvey discloses an electric resistance welding apparatus which is shown for attaching insulation to duct work comprising a supporting anvil with a surface for supporting a sheet metal duct work with a covering sheet of insulating material and a movable hammer member spaced from and movable relative to the anvil. The hammer member has one or more magnets for supporting a resistance welding pin and is movable to drive the pin through the insulating material to engage the sheet metal duct work. The hammer member and anvil are connected in an electric welding circuit to supply current from the hammer through the pin to the anvil to fuse the end of the pin to the sheet metal with the head of the pin holding a washer tightly against the insulating material. The hammer member and anvil are both copper with recesses having cylindrical copper electrode members removably positioned therein. In one embodiment, the hammer member recess is deeper than the copper electrode member, and the magnet fits the recess behind the electrode member. The copper electrode member may be recessed to contact the pin head portion when positioned on the hammer. In another embodiment, the pin is magnetic and the washer is non-magnetic. In this embodiment the hammer member has a flange at one end with recesses or passages in which there are positioned bar magnets to cooperate with the washer on the resistance welding pin to secure the pin on the hammer member.

U.S. Pat. No. 4,198,799 to McGrath discloses an apparatus for making fiber insulation from paper comprising a preshredder having a semi-cylindrical perforate basket with a passageway behind it. An air inlet extends behind the basket into the passageway and an air outlet is located at the front of the passageway. A flail rotatably mounted coaxial in the basket is driven by a motor for shredding paper deposited from a conveyor into the basket. A blower, connected to the preshredder, passes the paper segments to a surge bin where the air and paper segments are separated. The separated paper segments accumulate in the surge bin and are withdrawn from it at a constant predetermined rate by a conveyor and deposited into a duct which interconnects the surge bin and a finishing mill. The air then enters this duct to continue transporting the paper. A dry chemical dispensing device disperses flame retardant material into the duct. The finishing mill includes a large centrifugal fan rotatably mounted in a cylindrical cavity and driven by a motor. The cavity is covered by a perforate plate so that paper segments drawn centrally into the fan are ejected radially from its blades and exploded through the cover to form fiber insulation. The insulation is deposited into another surge bin for separation from the air and accumulation for bagging. The air passes through an air cleaner and is exhausted from the device. Accordingly, the air remains within the apparatus through the entire procedure thereby reducing dust and noise heretofore associated with such apparatus.

U.S. Pat. No. 6,935,379 to Buchanan discloses an improved insulation and an improved method for preparing and installing sheets of insulation having a vapor-barrier jacket or “finish” to ductwork and other fluid conduits or other surfaces. Anchor tabs are provided on the insulation, as are also studs for anchorage and mechanical attachment. Pressure sensitive tape with a split release strip is applied to the sheets prior to the installation of the sheets to the ductwork or other fluid conduits. The pressure sensitive tape is for sealing of any penetrations in the vapor-barrier by the mechanical attachment devices and for sealing of the edge of the vapor barrier jacket flange to the adjacent piece vapor-barrier jacket. The insulation is configured such that during storage and shipment, the jacket attachment flanges are positioned to avoid crumpling.

U.S. Pat. No. 6,755,218 to Whitty discloses a duct to receive duct wrap which is provided with a plurality of posts at different locations on and upstanding from the post to protrude through the duct wrap. Wrap retainers fit onto the post over the duct wrap securing the duct wrap on the duct.

U.S. Pat. No. 6,000,420 to Nicholson discloses an insulating jacket, that is removable and reusable, for insulating a hot or cold fluid distribution systems. The jacket is made of a plurality of sections which mate and seal together to effectively seal the pipe section and/or fitting from the surrounding ambient atmosphere. Each of the jacket sections can be made of a clear thermoplastic material and the entire assembly is designed to employ the trapped air, between the inside wall of the jacket and the system element, as the insulator. Plural jackets are used to form plural radially spaced trapped air gaps.

U.S. Pat. No. 4,576,846 to Noel discloses cellular plastic insulating tubes or cellular plastic insulating plates of a flexible plastic foam with a groove- and tongue-like closing system arranged along the longitudinal axis, in which the groove and tongue can be undercut. The tongue consists of a more rigid or stiffer material than the material forming the groove, or, if the tongue consists of the same material as the insulating cellular material, this is reinforced or stiffened.

U.S. Pat. No. 4,946,732 to Cohen discloses improved insulation segments for fluid conduits such as pipes and ducts, having a nontacky moisture resistant strip which extends along edges of the insulation which are adapted to be secured to other portions of the insulation, or to other insulation segments using a pressure sensitive, adhesive tape. This strip preferably comprises a cured adhesive which bonds to the paper or other surface to which it is applied which provides a good, dry, dirt free, smooth surface to which the pressure sensitive adhesive tape will strongly adhere.

U.S. Pat. No. 5,941,287 to Terito discloses a removable reusable insulating unit suitable for insulating exposed pipe sections forming components of an insulated pipe system, the unit having a hollow body constructed of an insulating material which is capable of being easily cut, the hollow body defining an interior and an exterior of the insulating unit, the interior sized to envelop an exposed pipe section on an insulated pipe system, and the body having at least two pipe receptor areas, each sized to accommodate a component of an insulated pipe system.

U.S. Pat. No. 6,907,907 to Maida discloses a pipe insulation cover which comprises a flexible planar and generally rectangular sheet having opposite long and short sides. Gathering structure is connected to each of the short sides, and releasably fastening structure is connected along each of the long sides of the flexible sheet. The long sides are releasably connected together after wrapping the sheet around pipe valve insulation, and the short sides are gathered around the pipe valve insulation by the gathering structure.

U.S. Pat. No. 4,605,043 to Grenier discloses an improved snap-on heat insulating jacket for ducting and a method uniquely designed for simplicity and ease of assembly. Resilient heat insulating material is laminated to a flexible sheet plastic main body provided with interlocking snap-on seam members positioned, when closed, for concealment by an external guard flap coated on its inwardly facing surface with pressure sensitive adhesive thereby to embrace the ducting with a cover having a substantially continuous smooth outer surface free of foreign matter collecting crevices and the like.

U.S. Patent Application No. 20040238059 to Shaffer discloses an insulated duct-wrap insulating product for an air duct that incorporates a wicking media to transport condensed water on the duct surface to be evaporated into the atmosphere. A wicking fabric, or fibrous media, incorporated as part of the insulating duct wrap is in contact with the metal air duct surface. A portion of the wicking fabric extends into the interior of the air duct, typically through joints in the duct system. When water vapor condenses on the air duct surface it is transported by the wicking fabric and evaporated from the wick surface within the air stream being transported by the ducting system.

U.S. Patent Application No. 20040238058 to Shaffer discloses an insulated duct-wrap insulating product for an air duct that incorporates a wicking media to transport condensed water on the duct surface to be evaporated into the atmosphere. A wicking fabric, or fibrous media, incorporated as part of the insulating duct wrap is in contact with the metal air duct surface. A portion of the wicking fabric extends into the interior of the air duct, typically through joints in the duct system. When water vapor condenses on the air duct surface it is transported by the wicking fabric and evaporated from the wick surface within the air stream being transported by the ducting system.

U.S. Patent Application No. 20040016470 to Whitty discloses a duct to receive duct wrap with a plurality of posts at different locations on and upstanding from the post to protrude through the duct wrap. Wrap retainers fit onto the post over the duct wrap securing the duct wrap on the duct.

It is an object of the present invention to provide a system for wrapping external ductwork.

It is a further object of the invention to provide a system to easily insulate external ductwork.

It is a further object of the present invention to provide an external ductwork insulation system which can be cut for the angles of the ductwork.

These and other objects of the invention will be described in detail below in accordance with the preferred embodiment.

### SUMMARY OF THE INVENTION

In a first embodiment the invention is directed towards an insulated duct wrap comprising an encasing exterior film which surrounds an insulation material and which is configured to wrap around the ductwork, said exterior film having an aperture to permit the escape of air; and a fastening system at each end for securing the wrap to the duct.

In a further embodiment, the invention is an insulated duct wrap comprising an encased UV resistant exterior film which surrounds an insulation material and which is configured to wrap around the ductwork, said exterior film covering an aperture to prevent the escape of air; and a fastening system at each end for securing the wrap to the duct.

In a still a further embodiment, the present invention is an insulated duct wrap comprising an enclosed exterior film which surrounds an insulation material and which is configured to wrap around the ductwork, said exterior film covering; an aperture to allow the escape of air; and a fastening system at each end for securing the wrap to the duct.

### DESCRIPTION OF THE FIGURES

FIG. 1 is a top view of the invention.

FIG. 2 is a side view of the invention as shown in FIG. 1.

FIG. 3 is a side view of the invention in use with a heating/cooling unit.

FIG. 4 illustrates a cross-section view of the invention.

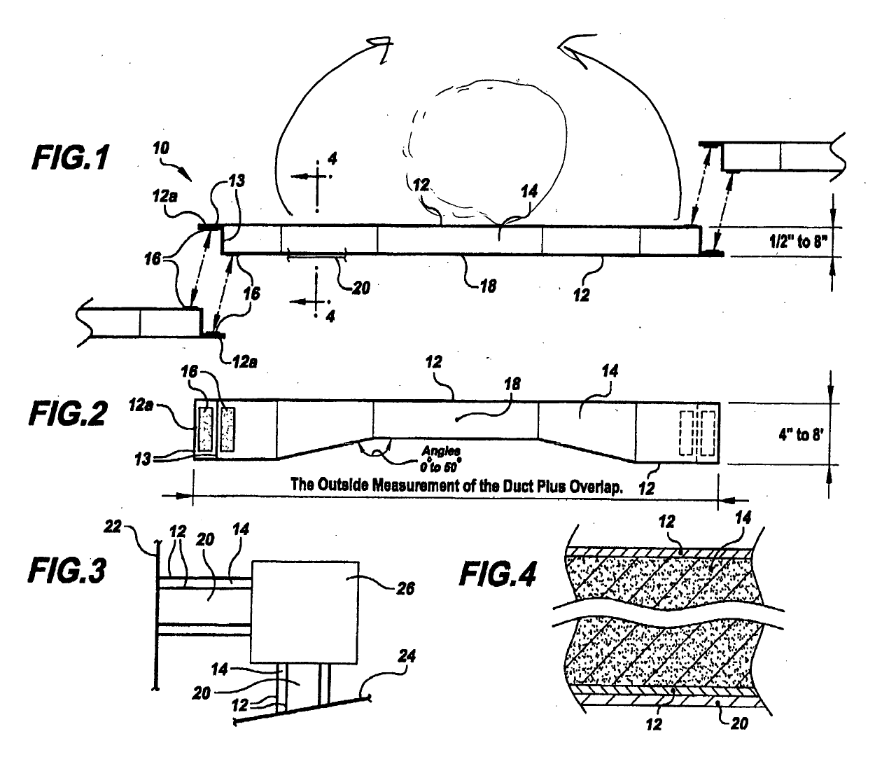

### DESCRIPTION OF THE PREFERRED EMBODIMENT

The present invention is directed to a reusable/removable insulation duct wrap for exterior mounted ductwork 20. The invention 10 is designed to reduce normal atmospheric temperatures, winds and moisture from adversely affecting exposed ductwork 20. The invention 10 will prevent the injection of foreign insulation particles into the air stream, the ductwork 20 is provided from the cooling/heating unit.

The invention 10 is intended to cover ductwork 20 of different sizes and shapes and in different film colors. The invention 10 will allow for the thickness of the insulation 14 desired for the duct wrap around ductwork 20.

The invention can be configured of ductwork 20 to an exterior side wall 22. For long lengths of exterior ductwork 20 running across roofs, the ground or other exterior applications representing various distances, the invention 10 would be made and installed in multiple adjacent sections, made in lengths to allow for exterior ductwork 20 supporting structures to completely wrap and cover the ductwork 20. The invention 10 may also be used as an effective insulation wrap on the interior ductwork of an enclosed building or a roof covered open sided structure.

The components of the invention 10 comprise exterior grade plastic or aluminized film 12. The film may be either translucent or a desired color. In the case of an aluminized film 12, film 12 should preferably be of the type used in building construction. The preferred film 12 if exterior grade plastic, preferably the type used in exterior agriculture applications, will preferably have a sufficient UV value, density and composition to retard degradation, preferably for twelve (12) months or more. The film 12 may be flat single sheet film 12 or film in tubular form. Preferably the film is extruded in tube form with gussets added to opposite sides of the tube.

The film 12 comprises the exterior covering of the invention 10. The insulation duct wrap includes the inside wall, outside wall, sides and overlapping flaps 12a. Using the measurements of the ductwork 20 to be covered by the invention 10, the film 12 is first cut to the length necessary including the overlapping flaps 12a. The film 12 is also cut to the correct width with addition of the necessary film 12 to form the sides of the insulation wrap structure and to allow for the thickness of the insulation 14 to be added. The previous width cut may not be necessary if the preferred extruded and gusseted tube with the correct measurements for the ductwork 20 to be wrapped is used.

The measured angles of the ductwork to be wrapped such as a duct bend angle or the roof slope angles 24 are cut (if required). If the film 12 is required to be cut for width and depth, radii or angles, these cut seams are bonded together by heat sealing and/or the use of adhesives to form a casing with the ends open where the overlapping flaps 12a are to be made.

The casing is then filled with the required thickness of insulation material 14. The insulation material 14 can comprise any loose fill or blanket type insulation, preferably rock wool insulation, fiber glass insulation or cellulose insulation. A hole 18 of sufficient size to allow the escape of excess internal air, when installing the invention 10, is made on the inside wall of the film 12 which will be placed against the ductwork 20.

At the open ends of the insulation 14 filled tube, overlapping flaps 12a are made. On one end, an overlapping flap 12a is made on the outside of the insulation wrap structure and on the opposite end, one overlapping flap is made on the inside of the insulation wrap structure. The film 12 is bonded at the ends of the total length of the insulation wrap structure across the width of the ends by heat sealing and/or the use of adhesives. Preferably this is done more than once at each end with a space of one (1) or more inches from the ends of the insulation wrap structure. Hook and loop fasteners 16 are then added.

The hook or loop fastener 16 is affixed on one end facing to the outside on inside overlapping flap 12a. On the other end of the insulation wrap structure, a hook or loop fastener 16 faces to the inside adjacent to the outside overlapping flap 12a. The hook and loop fasteners 16 are bonded to the film 12 using adhesives. Either one (1) hook or loop fastener 16 across the total width of the end of the insulation wrap structure, or more than one spaced across the total width of the end of the insulation wrap structure.

Preferably two (2) or more hook and loop fasteners 16 are installed on each end of the insulation wrap structure, one or more on the overlapping flap 12a and one or more adjacent to the overlapping flap 12a. The hook and loop fasteners 16 are installed so that those installed on one end of the insulation wrap structure face the outside of the insulation wrap structure, and those installed on the other end of the insulation wrap structure face the inside of the insulation wrap structure. This allows for proper alignment of hook and loop fastener 16 and closure when the ductwork 20 is wrapped with the invention 10.

The operation of the invention is now described. First, complete measurements of the ductwork 20 to be wrapped need to be made. These measurements include the dimensions of the length, width, depth, angle, radii and diameters (as presented, for example, by round ductwork). As, for example, an angle measurement could be a roof slope 24 or a bend radius on round shaped or various bend angles on rectangular shaped ductwork 20.

The insulation duct wrap invention 10 is then installed by positioning it so that its dimensions match those of the ductwork 20 to be wrapped and that the ductwork 20 is fully covered as invention 10 is wrapped around ductwork 20.

The ductwork 20 is wrapped and the ends of the invention 10 are aligned so that the one or more hook and loop fasteners 16 on one end are facing one or more hook and loop fasteners 16 on the other end.

Hook and loop fasteners 16 are then pressed firmly together. If multiple adjacent segments of the invention 10 are required, the same process is repeated until the entire ductwork 20 is wrapped with the insulation duct wrap. The removal of the insulation duct wrap is accomplished by simply pulling on one or more hook and loop fasteners 16 to separate them and unwrapping the ductwork 20.

The present invention has been described with reference to the included Figures. The true nature and scope of the invention is to be determined with reference to the enclosed claims.

1. An insulated duct wrap comprising:
an encasing exterior film which surrounds an insulation material and which is configured to wrap around the ductwork, said exterior film having an aperture to permit the escape of air; and
a fastening system at each end for securing the wrap to the duct.

2. An insulated duct wrap comprising:
an encasing UV resistant exterior film which surrounds an insulation material and which is configured to wrap around the ductwork, said exterior film covering an aperture to permit the escape of air; and
a fastening system at each end for securing the wrap to the duct.

3. The duct wrap of claim 1 wherein the insulation material is a loose fill material.

4. The duct wrap of claim 1 wherein the insulation material is a blanket type insulation.

5. An insulated duct wrap comprising:
an enclosed UV resistant exterior film which surrounds a loose filled or blanket type insulation material and which is angled to contour to an external
